(19) United States
(12) Patent Application Publication
(10) Pub. No.: US 2015/0134383 A1
(43) Pub. Date: May 14, 2015

(54) GRANULAR ASSET TRACKING USING LANDMARK TAGS

(71) Applicant: QUALCOMM Incorporated, San Diego, CA (US)

(72) Inventors: Jangwon Lee, San Diego, CA (US); An Mei Chen, San Diego, CA (US); Vijaya Datta Mayyuri, San Diego, CA (US); Paul David Milne, Oceanside, CA (US); Robert Morris Morandy, San Diego, CA (US); Gregory Gordon Rose, San Diego, CA (US)

(73) Assignee: QUALCOMM Incorporated, San Diego, CA (US)

(21) Appl. No.: 14/290,641

(22) Filed: May 29, 2014

Related U.S. Application Data
(60) Provisional application No. 61/902,743, filed on Nov. 11, 2013.

(51) Int. Cl. G06Q 10/06; G01S 13/75; G01S 5/02

(52) U.S. Cl. CPC G06Q 10/0631; G01S 5/0294; G01S 13/758
USPC 705/7.12

(57) ABSTRACT

An example method of asset tracking includes receiving, from each of one or more positioning devices, a corresponding position identification (ID) value, determining a tier value associated with each received position ID value, determining asset position information based on each received position ID value and each determined tier value, and transmitting the determined asset position information to a receiver.

This application claims the benefit of U.S. Provisional Application 61/902,743 filed 11 Nov. 2013, the entire content of which is incorporated by reference.

### TECHNICAL FIELD

This disclosure relates to asset management.

### BACKGROUND

Large organizations, such as corporations, governments, and universities, often invest large amounts of money into physical assets. Common examples of such physical assets may include computer equipment, audio/video equipment, IT infrastructure equipment, furniture, and other types of office equipment. Many organizations may also own or manage various types of industry-specific assets. For example, a semiconductor manufacturer may own test benches for testing chips, and a police force may own a fleet of bicycles. For a law firm or accounting firm, certain documents or papers may be considered assets. Generally speaking, any physical object may be considered by an organization to be an asset, and what constitutes an asset may vary from organization to organization.

As organizations get larger, it is not uncommon for them to occupy multiple floors of a building, multiple buildings, or even multiple sites, often making keeping track of all of the organization's assets quite challenging. As technology makes many assets smaller and more portable, managing such assets becomes even more challenging. In order to keep track of all of their assets, many organizations implement asset management programs that require assets to be associated with a particular location, a particular individual, or a particular group. Such systems, however, typically lose track of an undesirably large percentage of assets because assets get moved to new locations or transferred to new individuals without the system being updated. Many organizations also utilize asset management equipment to further keep track of all of their assets. Such equipment typically utilizes barcode or radio frequency identification (RFID) technology to determine the location of certain assets.

### SUMMARY

In one example a method includes receiving, from each of one or more positioning devices, a corresponding position identification (ID) value, determining a tier value associated with each received position ID value, determining asset position information based on each received position ID value and each determined tier value; and transmitting the determined asset position information to a receiver.

In another example, a device includes a memory and one or more processors. The one or more processors are configured to receive, from each of one or more positioning devices, a corresponding position identification (ID) value, determine a tier value associated with each received position ID value, determine asset position information based on each received position ID value and each determined tier value, and transmit the determined asset position information to a receiver.

In another example, a computer-readable storage medium is encoded with instructions. The instructions, when executed, cause one or more processors of a device to receive, from each of one or more positioning devices, a corresponding position identification (ID) value, determine a tier value associated with each received position ID value, determine asset position information based on each received position ID value and each determined tier value; and transmit the determined asset position information to a receiver.

In another example, an asset tracking system includes one or more landmark tags, each configured to transmit a corresponding position identification (ID) value, and an asset tag configured to receive the corresponding position ID values from the one or more landmark tags, determine a tier value associated with each received position ID value, determine asset position information based on each received position ID value and each determined tier value, and transmit the determined asset position information. The system further includes a receiver configured to receive the asset position information transmitted by the asset tag and relay the received asset position information, and a server configured to receive the asset position information relayed by the receiver, determine a unique asset identifier based on the received asset position information, and associate the receiver with the determined unique asset identifier.

The details of one or more examples are set forth in the accompanying drawings and the description below. Other features, objects, and advantages will be apparent from the description and drawings, and from the claims.

### BRIEF DESCRIPTION OF THE DRAWINGS

FIG. 1A shows an example asset tracking system that may be used in accordance with the techniques of this disclosure.

FIG. 1B shows an example of a receiver in accordance with the techniques of this disclosure.

FIG. 2 shows an example asset tracking system that may be used in accordance with the techniques of this disclosure.

FIG. 3 shows an example asset tracking system that utilizes landmark tags in accordance with the techniques of this disclosure.

FIG. 4A shows the operation of an asset tag according to the techniques of this disclosure.

FIG. 4B shows the operation of a landmark tag according to the techniques of this disclosure.

FIG. 5 shows an asset tracking system that represents a multi-tiered approach to the asset tracking system shown in FIG. 3.

FIG. 6 shows an example process by which one or more devices may perform various techniques of this disclosure.

### DETAILED DESCRIPTION

It has been increasingly significant to have an efficient and practical indoor asset tracking system. Among many challenges and hurdles towards large-scale practical indoor asset tracking system, the fine-granularity and location accuracy of the system, given inexpensive cost and longer lifetime of asset tags (e.g., usually required to last more than 2-3 years with coin-cell batteries) is the critical issue. Enabling fine-granularity up to desk (bench) level (sub 2 meter) is extremely challenging without increasing hardware cost and sophisticated technologies. Techniques of this disclosure are generally directed to addressing these potential problems, and propose a simple and inexpensive, yet fine-granular asset tracking system.

Achieving fine-granular resolutions/accuracies has significant importance and may provide new business/service opportunities with respect to indoor positioning systems. Several existing indoor positioning systems implement impractical solutions that require greater hardware and deployment costs. This disclosure proposes a new asset tracking system by introducing a separate, simple, and inexpensive landmark tag which can be used as a reference point. Additionally, this disclosure proposes tiered approaches, so that finer-granularity positioning can be achieved.

In current asset location detection systems, an asset tag affixed to the asset typically transmits a message to a receiver, and based on which receiver picks up the message, the system determines an approximate location for the asset tag. More sophisticated systems may use triangulation of multiple receivers and/or measurements of signal strength to attempt to determine a more accurate location for the asset. Achieving any sort of fine granularity, however, with these receiver-based systems is often cost prohibitive, because of the number of receiver devices required. Receiver devices tend to be fairly expensive relative to the cost of other system components in the asset location detection system.

This disclosure introduces a new system component for determining locations at a fine granularity. This new component may be referred to in this disclosure as a landmark tag or, more generically, as a positioning device. In contrast to existing systems where a location is determined based on a signal transmitted by an asset tag, according to the techniques of this disclosure, a location can be determined based on a signal received by an asset tag. An asset tag can receive position signals from one or more landmark tags. The position signal transmitted by the landmark tag and received by the asset tag may include a unique position identification (ID) value that uniquely identifies the landmark tag. The asset tags can then transmit to the receiver asset position information for determining a position of the asset tag. Such asset position information may, for example, include the position ID values of all landmark tags for which a signal is detected, only the position ID value of the landmark tag which has the highest signal strength, the position ID values of the landmark tags with the two highest signal strengths, and/or some other such asset position information based on the received position ID values. Based on the asset position information transmitted from the asset tag, a central server, which knows the locations of the landmark tags, may calculate the location of the asset tag. As it is contemplated that the landmark tags will be inexpensive compared to the receivers, a relatively large number of landmark tags may be used to achieve fine granularity.

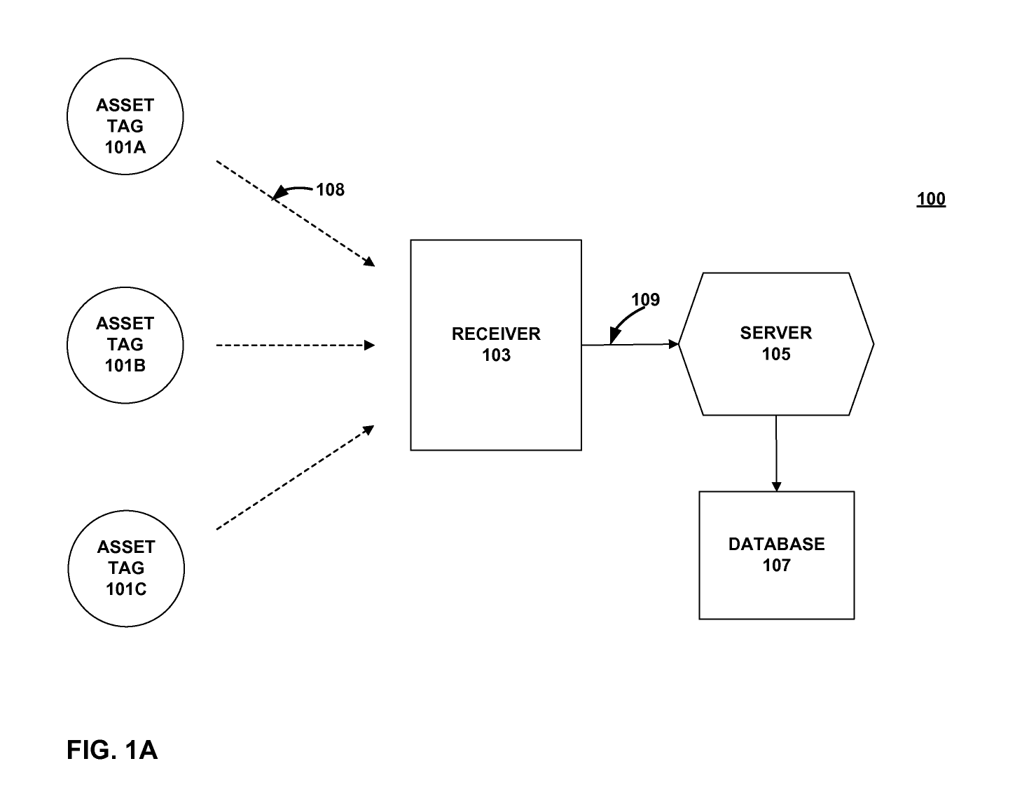

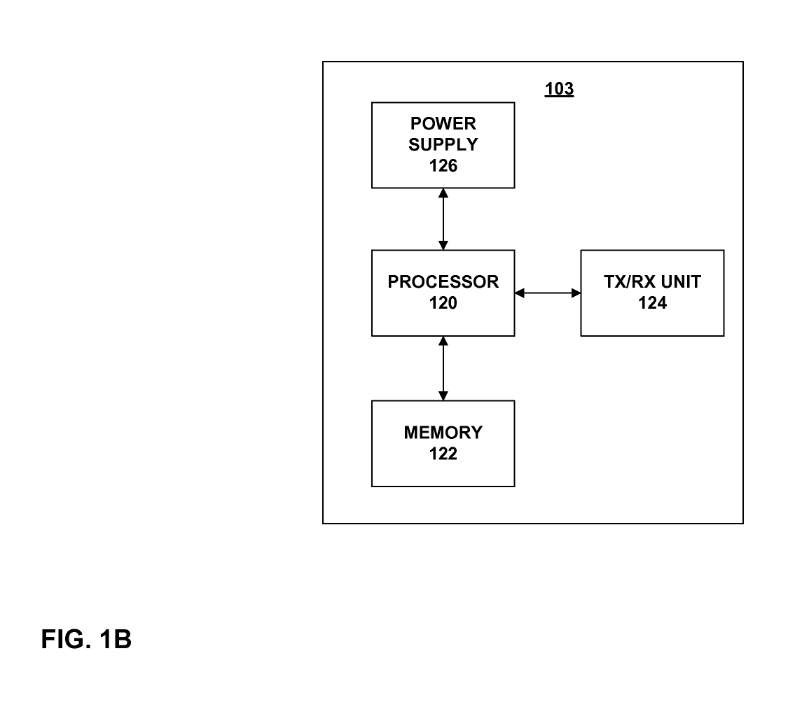

FIG. 1A shows an example asset tracking system 100 that includes asset tags 101A-101C, receiver 103, server 105, and database 107. Asset tags 101A through 101C are configured to be attached to various assets, and each of asset tags 101A through 101A may be associated with a unique asset tag ID. Each of asset tags 101A and 101C may be configured to transmit a signal that can be detected by various receivers, such as receiver 103. Receiver 103 can then transmit (e.g., relay) to server 105 information that includes the unique asset tag IDs detected by receiver 103. The association of receiver 103 with a unique asset tag ID may then be stored in database 107. Tags 101 and receiver 103 may be configured to perform wireless communication.

Asset tags 101A-101C are configured to be attached to various assets, and each of asset tags 101A-101C may be associated with a unique asset tag ID. Each of asset tags 101A-101C may be configured to transmit a signal that can be detected by various receivers, such as receiver 103. Additionally, each of asset tags 101A-101C may determine asset position information by processing received data. FIG. 1, for example, shows asset tag 101A transmitting information to receiver 103 over communication channel 108. Asset tags 101B and 101C may communicate with receiver 103 in a similar manner to that of asset tag 101A. Receiver 103 can then transmit (e.g., relay) to server 105, over one or more communication channels, information that includes the unique asset tag IDs detected by receiver 103. As will be explained in greater detail below, in addition to the unique asset tag ID, receiver 103 may transmit or relay additional information for the asset tag ID, such as tier information, to server 105. The association of receiver 103 with a unique asset tag ID may then be stored by server 105 in database 107. The usage information associated with a particular asset tag ID may also be stored in database 107.

Asset tags 101A-101C may either engage in 1-way communication or 2-way communication with receiver 103. An asset tag configured only for 1-way communication may send information to receiver 103 but not receive information from receiver 103. Limiting the asset tag to 1-way communication may simplify the hardware requirements and possibly make the asset tags smaller and less expensive to manufacture. Limiting the asset tag to 1-way communication may additionally reduce battery consumption. In some implementations, asset tags 101A-101C may engage in 2-way communication, such that each of asset tags 101A-101C may both send information to and receive information from receiver 103. In a system with asset tags configured for 2-way communication, server 105 may initiate a real-time inquiry of the asset usage detected by the asset tags.

Database 107 may also store a location for receiver 103. Thus, based on the location of receiver 103, server 105 can provide to a user of asset tracking system 100 an estimate of the location for an asset tag. For example, if receiver 103 detects a signal transmitted by asset tag 101A, then it can be determined that asset tag 101A is in a room, building, or other location associated with, e.g., in proximity to or reception range of, receiver 103. Although not shown in FIG. 1A for simplicity, asset tracking system 100 may include multiple receivers dispersed across an area for which assets are to be monitored. As introduced previously, in addition to storing a location for asset tags 101A-101C, database 107 may also store usage information associated with each asset tag.

Server 105 and database 107 are generally intended to represent any computing system and data storage system and may take many different forms. Server 105 and database 107, collectively, may, for example, comprise an application server, a catalog server, a database server, a file server, a home server, a mobile server, a proxy server, a stand-alone server, a web server, a personal computer, a mobile device such as a smartphone or tablet, or any other type of network device. In some examples, some or all of the functionality described herein relative to server 105 and database 107 may be performed by receiver 103.

Communication channel 108 generally represents any suitable communication medium, or collection of different communication media, for transmitting data between asset tag 101A and receiver 103. Communication channel 108 is usually a relatively short-range communication channel, and may implement a physical channel structure similar to Wi-Fi, Bluetooth, 3G, 4G, cellular, or the like, such as implementing defined 2.4, GHz, 3.6 GHz, 5 GHz, 60 GHz or Ultrawideband (UWB) frequency band structures. However, communication channel 108 is not necessarily limited in this respect, and may comprise any wireless or wired communication medium, such as a radio frequency (RF) spectrum or one or more physical transmission lines, one or more proprietary communication protocols, or any combination of wireless and wired transmission media.

Communication channel 109 generally represents any suitable communication medium, or collection of different communication media, for transmitting data between receiver 103 and server 105. Communication channel 109 may be any type of short-range or long-range communication channel, and may comprise any wireless or wired communication medium, such as a radio frequency (RF) spectrum or one or more physical transmission lines, or any combination of wireless and wired media. In other examples, communication channel 109 may form part of a packet-based network, such as a wired or wireless local area network, a wide-area network, or a global network such as the Internet. Additionally, communication channel 109 may be used by receiver 103 and server 105 to create a peer-to-peer link.

FIG. 1B shows an example of receiver 103 in accordance with the techniques of this disclosure. Receiver 103 includes one or more processors (processor 120), one or more memories (memory 122), a transmission and receiving (TX/RX) unit 124, and a power supply 126. The components of receiver 103 may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof

Processors 120 may implement functionality and/or execute instructions within receiver 103. Processor 120 is generally intended to represent all processing capabilities of receiver 103. It is contemplated that in some implementations, the processing capabilities of receiver 103 may actually be distributed across multiple processing elements. Processors 120 on receiver 103 may receive and execute instructions stored by memory 122 that control the functionality of TX/RX unit 124 and other units within receiver 103. These instructions executed by processors 120 may cause receiver 103 to store information within or retrieve information from memory 122 during program execution.

Memory 122 within receiver 103 may store information for processing during operation of receiver 103. Memory 122 may include temporary memory that is not for long-term storage. Such temporary memory be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art. Memory 122 may also include one or more computer-readable storage media. Such computer-readable storage media may be configured to store larger amounts of information than volatile memory and may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Memory 122 may also store program instructions for execution by processor 120 and/or data associated received from any of asset tags 101A-101C. Memory 122 in receiver 103 is generally intended to represent all the memory that may be contained in receiver 103, including, for example, caches, RAM, and storage media.

TX/RX unit 124 may include various mixers, filters, amplifiers, modems, and other components designed for signal modulation, as well as one or more antennas and other components designed for transmitting and receiving data. TX/RX unit 124 is generally intended to represent all the communication components and functionality of receiver 103. Receiver 103 may be configured to transmit and receive data using multiple communications protocols. As one example, TX/RX unit 124 may receive information from any of asset tags 101A-101C using Bluetooth and transmit (e.g., relay) information to server 105 using WiFi and/or a wired LAN connection.

Power supply 126 generally represents any power source or combination of power sources that may be used to power receiver 103. It is contemplated that receiver 103 may be larger than asset tags 101A-101C but still generally small, such as the size of a smoke detector, for example. Accordingly, it is contemplated that power supply 126 may also be relatively small for receiver 103. For example, it is contemplated that some implementations of receiver 103 may operate using one or more AA, AA, C, D, or 9V batteries. In some implementations, receiver 103 may include multiple power sources, such as wall power and battery power.

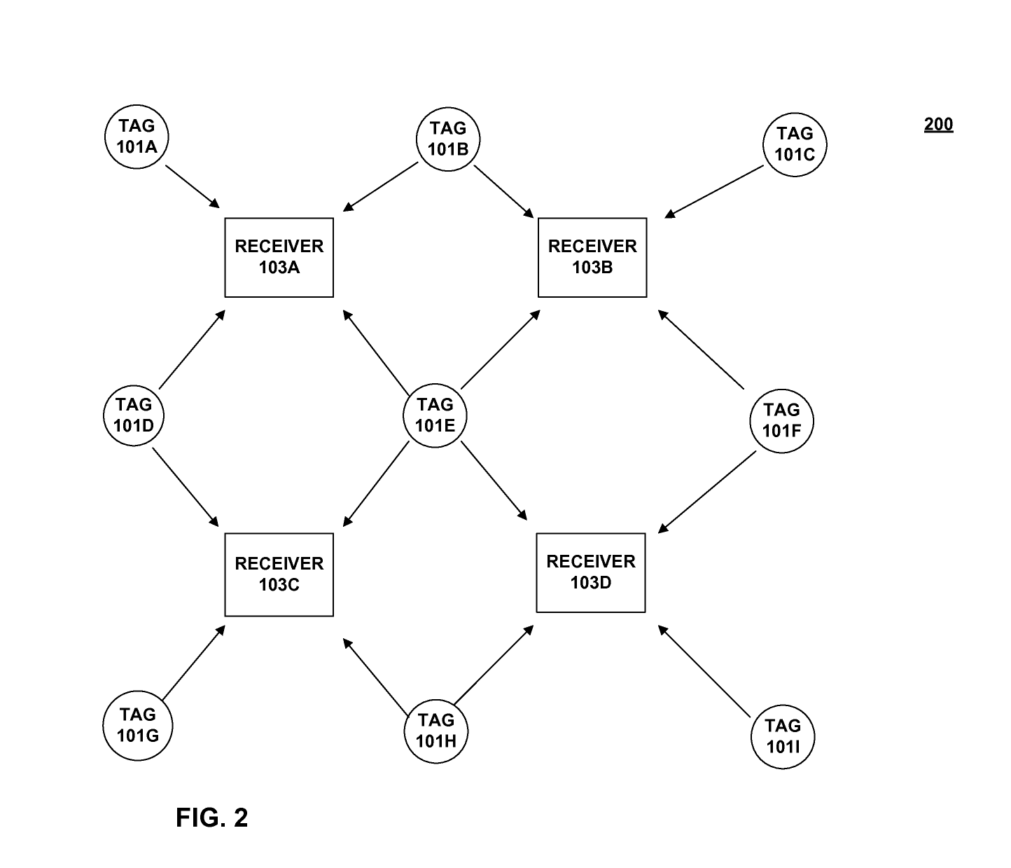

FIG. 2 shows an example of asset tracking system 200. Asset tracking system includes tags 101A-101I and receivers 103A-103D. Asset tags 101 transmit messages. The message may include identifications (IDs). In some examples, the IDs may uniquely identify the asset tags. Asset tracking system 200 generally operates in the same manner as asset tracking system 100 of FIG. 1A, but FIG. 2 shows more tags and receivers, which may be distributed at different locations in a space or region. The arrows in FIG. 2 generally correspond to messages being transmitted by asset tags 101A-101I and are detected by receivers 103A-103D. As can be seen in the example of FIG. 2, the messages of some asset tags (e.g. asset tag 101E) are detected by as many as four receivers, while the message of some asset tags (e.g. asset tags 101A) is detected by only one receiver. Although not shown in FIG. 2, receivers 103A-103D may transmit, to a central server such as server 105 of FIG. 1A, for example, information identifying the IDs of asset tags for which it has detected messages. Thus, based on which receivers detect the asset tag's message, the central receiver can determine an approximate estimate of the asset tag's location.

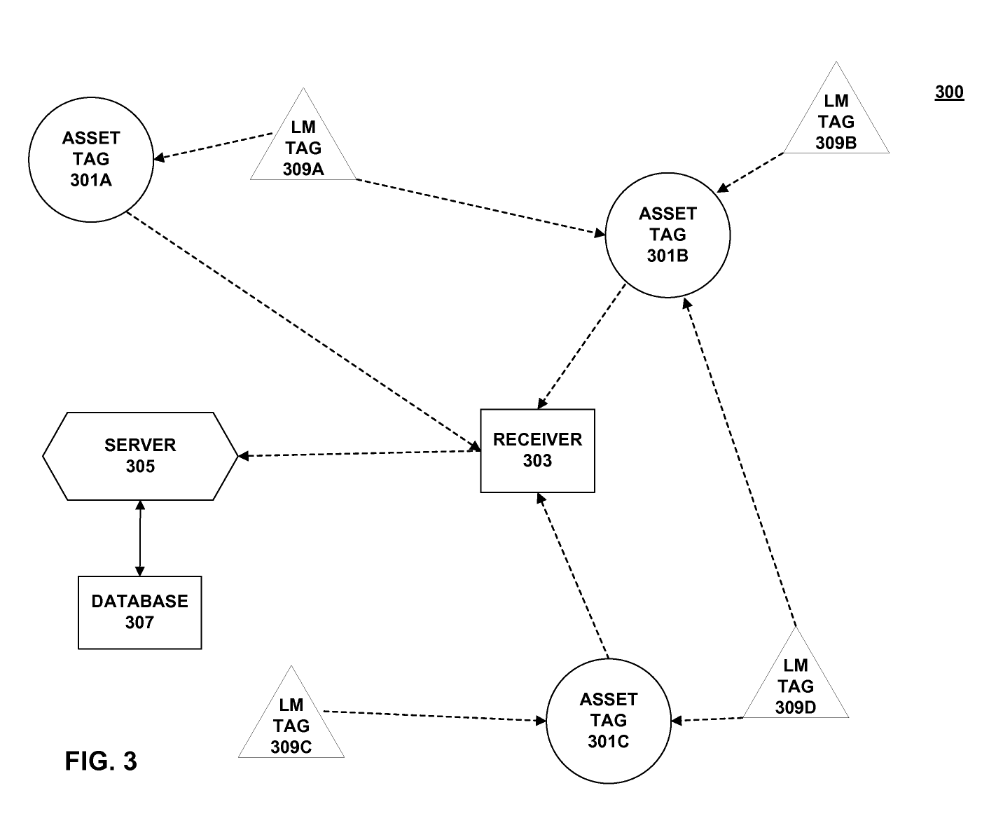

FIG. 3 shows an example system in accordance with the techniques of this disclosure that includes landmark (LM) tags. Asset tracking system 300 of FIG. 3 includes asset tags 301A-301C, receiver 303, server 305, database 307, and LM tags 309A-309D (collectively “LM tags 309”). The locations of LM tags 309 are known by system 300 and stored in database 307. LM tags 309 transmit messages that include position identification (ID) values, and database 307 associates the position ID values with physical locations. The position identification values may include actual position information (e.g., asset tags 301A-301C may be configured to receive messages that include the position ID values from LM tags 309). LM tags 309 are examples of positioning devices in accordance with one or more aspects of this disclosure. Asset tags 301A-301C may transmit to receiver 303 received position ID values as well as their respective asset tag IDs. Receiver 303 may, in turn, transmit (e.g., relay) one or more of the received asset tag IDs and any associated position ID values to server 305. Based on the position ID values received by an asset tag, and potentially also based on the receiver that receives the asset tag message, a location for a particular asset tag may be determined (e.g., by server 305), and stored in database 307. As it is contemplated that LM tags 309 will be small and inexpensive compared to receiver 303, a relatively large number of LM tags may be deployed, thus enabling location to be determined with a finer granularity compared to current asset tracking systems. As discussed above, LM tags 309 are examples of positioning devices, in accordance with one or more aspects of this disclosure.

Asset tags 301 and LM tags 309 may implement various hardware solutions. For instance, each of asset tags 301 and/or each of LM tags 309 may include one or more processors (e.g., programmable processors), and one or more memory units. Additionally, each of asset tags 301 and LM tags 309 may be lower-cost than receiver 303, due to reduced resource requirements. Each of LM tags 309 may be lower-cost than each of asset tags 301, as LM tags 309 may only transmit data, whereas asset tags 301 may receive as well as transmit data. Additionally, asset tags 301 may be configured to perform various levels of processing of data (e.g., to determine tier information from the received data). In various examples, one or more of asset tags 301 and LM tags 309 may implement radio frequency (RF) based technologies to transmit and receive data (e.g. asset tag IDs and/or position ID values). For instance, one or more of asset tags 301 and LM tags 309 may implement one or more short-range RF technologies for transmitting and receiving data. By implementing short-range communication technologies such as short-range RF hardware, asset tags 301 and/or LM tags 309 may provide one or more potential advantages. As one example, asset tags 301 and LM tags 309 may, by implementing short-range RF hardware, reduce costs incurred in deploying asset tracking system 300. Because short-range RF hardware tends to be a low-cost alternative to other tracking systems (e.g., systems that implement long-range communication systems), asset tracking system 300 may accommodate a greater number of assets (e.g., to be identified by asset tags 301) and/or greater accuracy with respect to position ID values (e.g., as identified by LM tags 309). Another potential advantage provided by implementing short-range RF hardware is that asset tags 301 and/or LM tags 309 may cause less interference (e.g., harmful signal interference) among one another.

In various implementations of asset tracking system 300, one or more of asset tags 301 and/or LM tags 309 may incorporate short-range devices that implement Bluetooth® technologies. For instance, one or more of asset tags 301 and/or LM tags 309 may include Bluetooth® Low Energy (“BLE”) or Bluetooth® 4.0 technologies. In examples where one or more of asset tags 301 incorporate BLE technology, each of such asset tags 301 may be powered by a small coin-cell battery. Additionally, such BLE devices (which are powered by small coin-cell batteries) may be small in size and relatively inexpensive when compared to other types of communication devices. Additionally, based on being battery-powered, asset tags 301 may be portable, and therefore may be physically moved with the corresponding asset being identified. In this manner, techniques of this disclosure may provide hardware configurations for asset tags 301 that are efficient in terms of resource (e.g., energy) consumption, space consumption, and portability.

Additionally, in examples where one or more of LM tags 309 incorporate BLE technology, LM tags may be powered either by battery or by plug-in outlets (e.g., wall outlets that provide alternating current, or AC). For example, because one or more of LM tags 309 may indicate a fixed location (e.g., a particular pillar number in a warehouse), LM tags 309 may not require the same portability as asset tags 301. Additionally, associations between each of LM tags 309 and its corresponding location information may be provisioned and stored at server 305 and/or database 307. As a result, portability may not be important (and may, in fact, be undesirable) with respect to LM tags 309. In turn, due to the diminished portability requirements, LM tags 309 may optionally utilize wall outlet or wall socket power, thereby mitigating or potentially eliminating the need to replace batteries. In some examples, LM tags 309 may be equipped with batteries as a “backup” power source, in case of any outlet/socket power failure.

According to various implementations of the techniques described herein, receiver 303 may incorporate BLE technology. For instance, receiver 303 may include, be, or be part of a short-range communication device that implements BLE technology. In various examples, receiver 303 may perform a so-called “observer” or central role, by monitoring (or “listening”) for asset messages sent by one or more of asset tags 301. In turn, receiver 303 may transmit or relay any asset messages received from asset tags 301 to server 305. In some examples, receiver 303 may transmit data to server 305 using short-range communication, such as BLE-based or other Bluetooth®-based capabilities.

In other examples, receiver 303 may transmit data to server 305 using other (e.g., long-range) communication mechanisms, such as those provided by internet protocol (IP), WiFi®, Ethernet, 3G, 4G, etc. In examples where receiver 303 is configured to transmit or relay data to server 305 using long-range communication, receiver 303 may be equipped with both BLE technology (to listen for and receive asset messages), as well as long-range communication technology (to transmit or relay data to server 305). For instance, receiver 303 may be equipped with a BLE-based module, as well as an IP network capable module. In such examples, receiver 303 may be more expensive than any of asset tags 301 and LM tags 309, due to the inclusion of both BLE and IP network capable modules. To mitigate added costs, techniques of this disclosure provide for deploying a single receiver for multiple asset tags. For instance, in the implementation illustrated in FIG. 3, a single receiver 303 listens for and relays asset messages for multiple asset tags 301.

One or both of server 305 and database 307 may maintain data to track the assets identified by asset tags 301. Additionally, server 305 and/or database 307 may provision, establish, and track associations between each of LM tags 309 and the associated location. For instance, database 307 may store the asset-asset ID associations for asset tags 301, and the LM tag-position ID associations for LM tags 309. In this example, server 305 may access the various associations by reading the pertinent data from database 307. Additionally, in case any of the associations are to be updated, server 305 may write the updates to database 307, to maintain up-to-date association information with respect to asset tags 301 and LM tags 309. According to some examples of this disclosure, server 305 may apply one or more proximity algorithms to determine asset positions corresponding to asset tags 301 based on position ID values and tier information included in asset messages relayed by receiver 303.

In various implementations of the techniques described herein, LM tags 309 may periodically send position ID information (e.g., in the form of “landmark messages”) to asset tags 301. In examples, the time period between consecutive transmissions of position ID values may be pre-set, and may be referred to herein as a “sleep time” associated with the particular one or more of LM tags 309. Similarly, asset tags 301 may implement a sleep time between transmitting asset messages to receiver 303. In some examples, one or more of asset tags 301 may implement an ad hoc or reactive sleep time, such as by transmitting an asset message to receiver 303 only in response to receiving an asset message from one of LM tags 309.

In various instances, asset tags 301 may implement longer sleep times than LM tags 309. In other words, according to these examples, LM tags 309 may transmit landmark messages more frequently than asset tags 301 transmit asset messages. As one example, if LM tags 309 are not entirely reliant on battery power, LM tags 309 may be better equipped than asset tags 301 to more frequently transmit messages.

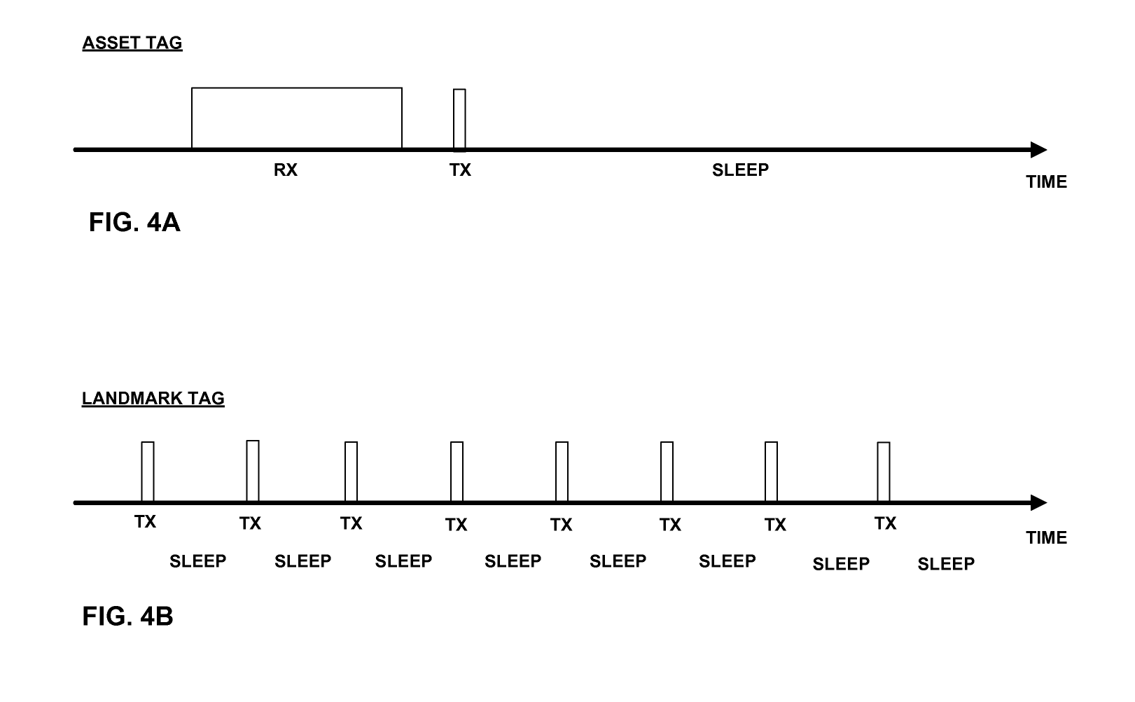

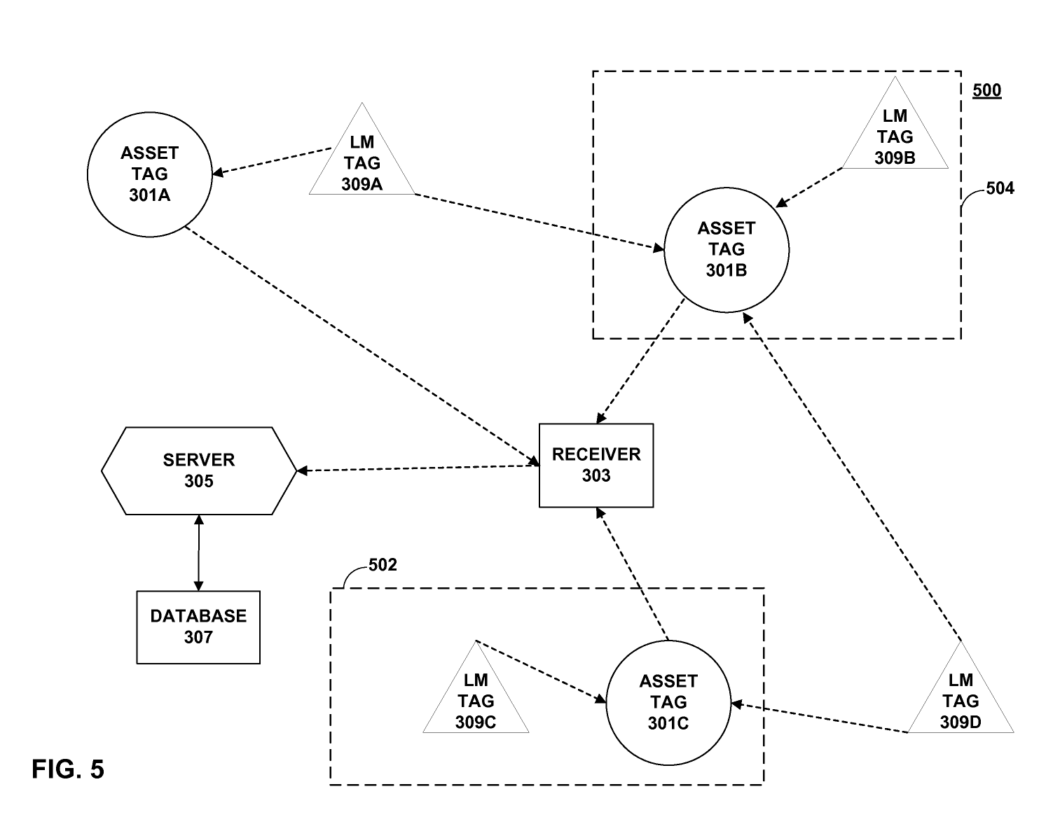

FIG. 4A shows the operation of an asset tag according to the techniques of this disclosure. An asset tag, such as one or more of asset tags 301 illustrated in FIG. 3, has three modes of operation: receiving (RX), transmitting (TX), and sleep. When receiving, the asset tag is, for example, detecting signals transmitted by landmark tags. When transmitting, the asset tag is transmitting, to a receiver, for example, position ID values received from landmark tags, as well as other information such as an asset tag ID value.

FIG. 4B shows the operation of a landmark tag according to the techniques of this disclosure. A landmark tag has two modes of operation: transmitting (TX) and sleep. Hence, in some examples, landmark tags may transmit only, and not receive. In other examples, landmark tags may transmit and receive. In order to conserve battery power, the landmark tag may spend more time in the sleep mode than in the transmitting mode. The length of the sleep modes and the transmit modes may be selected in coordination with the lengths of the transmitting, receiving, and sleep modes of the asset tag, such that an asset tag will transmit at least once while the asset tag is in the receiving mode.

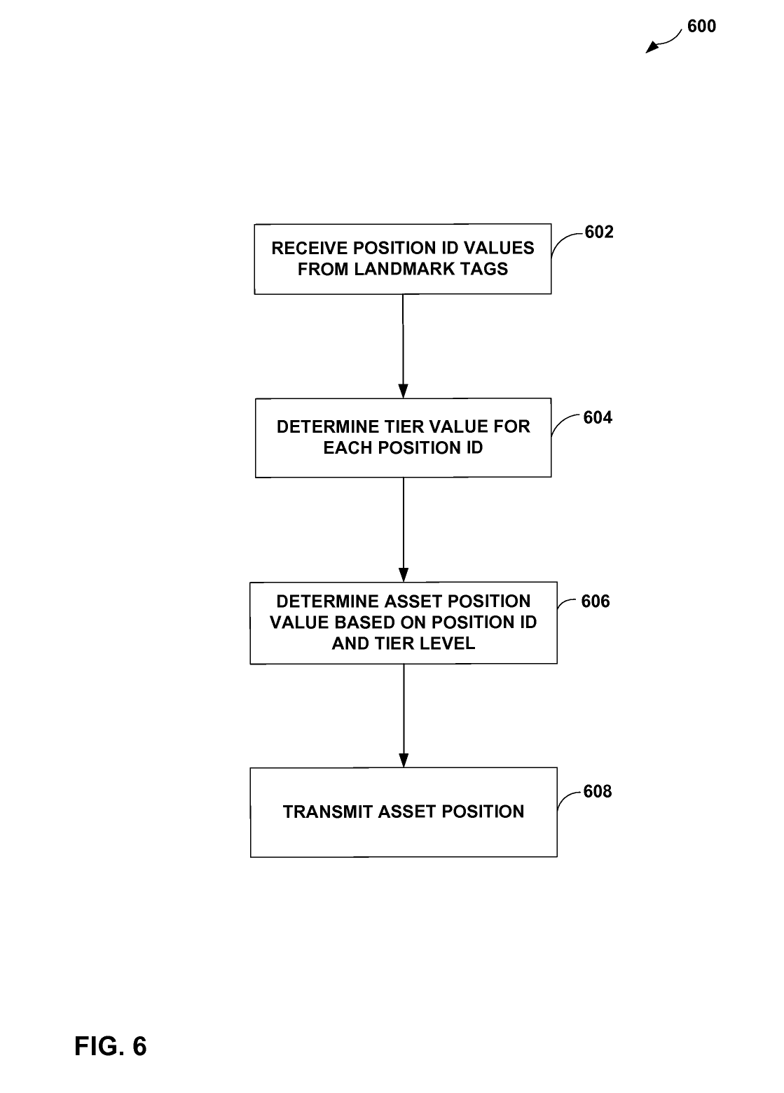

FIG. 5 shows asset tracking system 500, which represents a multi-tiered approach to asset tracking system 300 shown in FIG. 3. In various implementations, techniques of this disclosure may be implemented to provide varying levels of precision or granularity to the asset tracking techniques described herein. For instance, in asset tracking system 500, LM tags 309 may be classified into two tiers, namely, tier 1 and tier 2 (alternatively, “first tier” and “second tier”). In the example of FIG. 5, LM tags 309B and 309C may represent tier 1 LM tags, while LM tags 309A and 309D may represent tier 2 LM tags. LM tags 309B and 309C (“tier 1 LM tags 309”) may transmit position ID values using a lower signal strength than LM tags 309A and 309D (“tier 2 LM tags 309”).

Additionally, tier 1 LM tags 309 may provide fine-granular (or “fine-grained”) position information, while tier 1 LM tags 309 may provide coarse-granular (or “coarse-grained”) position information. For instance, tier 1 LM tags 309 may indicate a more precise position (e.g., a shelf number), while tier 2 tags 309 may indicate a more general position (e.g., a pillar number in a warehouse). In the example of FIG. 5, range boundary 502 indicates that asset tag 301C is within reception range of tier 1 LM tag 309C. Similarly, range boundary 504 indicates that asset tag 301B is within reception range of tier 1 LM tag 309B.

Conversely, as shown in FIG. 5, asset tag 301A is not within a range boundary, and is therefore not within reception range of any of tier 1 LM tags 309. As shown, asset tag 301A receives coarse-granular position ID value information from tier 2 LM tag 309A. In the case of asset tag 301B, asset tag 301B receives fine-granular position ID value information from tier 1 LM tag 309B, as well as coarse-granular position ID value information from tier 2 LM tags 309A and 309D. Similarly, asset tag 301C receives fine-granular position ID value information from tier 1 LM tag 309C and coarse-granular position ID value information from tier 2 LM tag 309D. In general, each of asset tags 301 may determine asset position information using the data (e.g. location and/or tier information) received from LM tags 309.

In various implementations of the multi-tiered techniques described herein, LM tags 309 may transmit their respective tier levels, in addition to the position ID values of their respective locations. For instance, LM tag 309A may transmit a corresponding position ID value along with a “tier 1” indicator, LM tag 309B may transmit a corresponding position ID value along with a “tier 2” indicator, and so on. In turn, asset tags 301 may utilize the received tier indicators in a variety of ways, in accordance with various techniques described herein.

In one example implementation, each of asset tags 301 may determine whether it has received any landmark messages with tier 1 indicators. If an asset tag 301 has received a tier 1 indicator, that asset tag 301 may disregard any received landmark messages with tier 2 indicators. Additionally, such an asset tag 301 may determine whether it has received multiple landmark messages with tier 1 indicators. If the asset tag 301 has received multiple tier 1 indicators, the asset tag 301 may determine which of the received tier 1 landmark messages has the greatest signal strength (expressed by a received signal strength indicator, or ‘RSSI’). In turn, the asset tag 301 may embed the position ID value of the tier 1 landmark signal with the greatest RSSI in the asset messages to be transmitted. For instance, asset tag 301C may receive a tier 1 landmark message from LM tag 309C, and a tier 2 landmark message from LM tag 309D. According to this example implementation, asset tag 301C may disregard the tier 2 landmark message received from LM tag 301D, based on having received the tier 1 landmark message from LM tag 301C. Additionally, based on having received only a single tier 1 landmark message, asset tag 301C may select the position ID value received from tier 1 LM tag 309C for inclusion with asset messages to be transmitted to receiver 303.

In another example implementation, asset tags 301 may include, with the transmitted asset messages, position ID value information for a single tier 1 landmark and a single tier 2 landmark, provided that the asset tag 301 has received at least one landmark message of each tier. According to this implementation, if an asset tag 301 receives multiple landmark messages of the same tier, such an asset tag 301 may choose from the equally-tiered landmark messages, based on the RSSI. In the example of FIG. 5, asset tag 301B may receive a tier 1 landmark message from LM tag 309B, and may receive separate tier 2 landmark messages from each of LM tags 309A and 309D. In this example, asset tag 301B may select the tier 2 landmark message received from LM tag 309A (based on a greater RSSI), and the tier 1 landmark message received from LM tag 309B (based on it being the only tier 1 landmark message received). In turn, asset tag 301B may include the position ID values of both tier 1 LM tag 309B and tier 2 LM tag 309B with all asset messages transmitted to receiver 303.

In this way, techniques of this disclosure may be implemented in a tiered manner. While FIG. 5 is described with respect to a two-tiered asset tracking system 500, it will be appreciated that the techniques described herein may be implemented in systems with three or more tiers of landmark tags. Additionally, the techniques may further enable asset tags 301 to relay varying amounts or combinations of position ID information to receiver 303, such as a single highest-tiered position, the two top-tiered positions (selected from any number of available tiers), and so on.

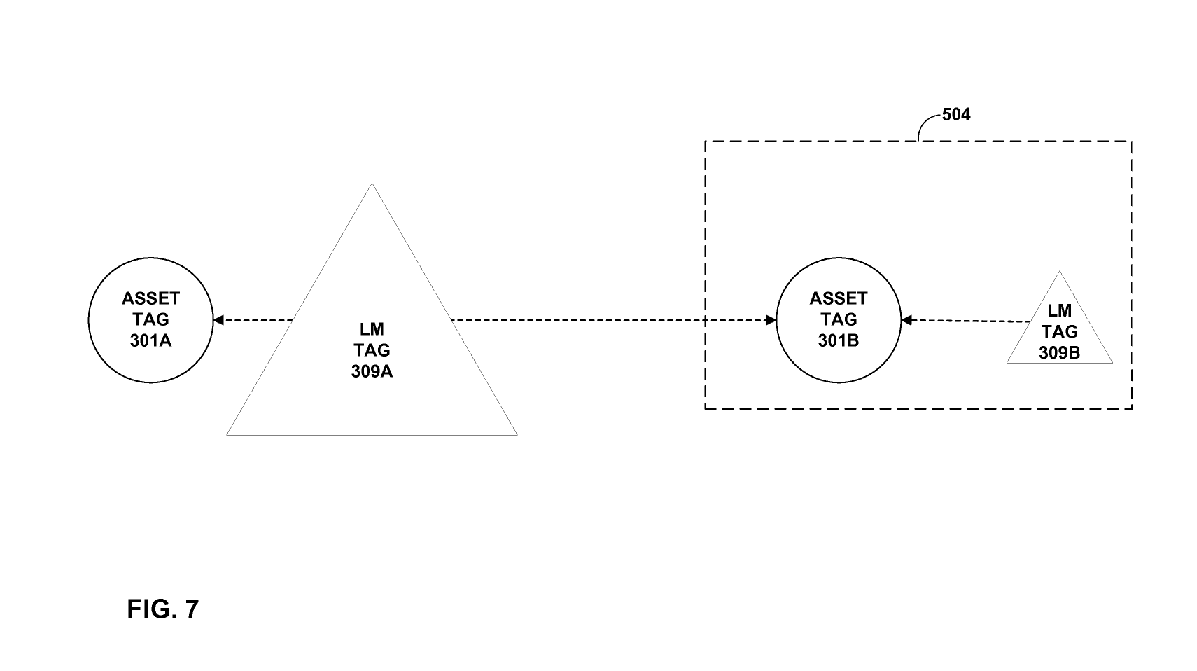

FIG. 6 shows an example process 600 by which one or more devices may perform various techniques of this disclosure. Although process 600 may be performed by a variety of devices, for ease of discussion purposes only, process 600 is described herein with respect to asset tags 301 and LM tags 309 illustrated in FIGS. 3 and 7. Process 600 may begin when asset tags 301 received position ID values from LM tags 309 (602). Additionally, asset tags 301 may determine a tier value associated with each received position ID value (604). For instance, asset tags 301 may receive a tier indicator in a landmark message received from each of LM tags 309. A tier value of one may be associated with finer-grained location information, while a tier value of two may be associated with coarser-grained location information.

Asset tags 301 may determine an asset position based on the one or more received position ID values and the tier level of each received position ID value (606). As described with respect to FIG. 5, asset tags 301 may determine asset position information in a variety of ways, using one or more received position ID values and their corresponding tier levels. Additionally, asset tags 301 may transmit the determined asset position information, such as to receiver 303 (608).

FIG. 7 illustrates example implementations of various components discussed above with respect to FIG. 5. More specifically, FIG. 7 illustrates asset tags 301A and 301B, tier 2 LM tag 309A, and tier 1 LM tag 309B. FIG. 7 also illustrates range boundary 504, which indicates that asset tag 301B is within reception range of tier 1 LM tag 309B.

While FIG. 7 is not drawn to scale, the example implementation shown in FIG. 7 illustrates that, in some examples, second tier LM tags may be larger than first tier LM tags. For instance, the physical dimensions (or size) of tier 2 LM tag 309A may be greater than the physical dimensions/size of tier 1 LM tag 301B, as in the example of FIG. 7 (although not drawn to scale). In various use-case scenarios, the larger size of tier 2 LM tag 309A in comparison to tier 1 LM tag 309B may correlate (e.g., be directly proportional to) the difference between the respective signal strengths at which tier 2 LM tag 309A and tier 1 LM tag 309B transmit data.

For instance, tier 2 LM tag 309A may transmit data (e.g., ID values) at a greater (also referred to as “higher” or “stronger”) signal strength than the lower (or “weaker”) signal strength at which tier 1 LM tag 309B transmits data. As described with respect to FIGS. 3 and 5, tier 2 LM tag 409A may transmit ID values at the greater signal strength in order to support coarse-granular aspects of the asset-tracking techniques described herein. Conversely, tier 1 LM tag 309B may transmit ID values at the lower signal strength to support fine-granular aspects of the asset-tracking techniques described herein.

In this manner, techniques of this disclosure may be directed to a method including receiving, from each of one or more positioning devices, a corresponding position identification (ID) value, determining a tier value associated with each received position ID value; determining asset position information based on each received position ID value and each determined tier value; and transmitting the determined asset position information to a receiver. For instance, the method described above may be a method of asset tracking According to some examples, determining the tier value associated with each received position ID value includes determining that a first received position ID value is associated with a first tier, and determining that a second received position ID value is associated with a second tier. In some examples, determining the asset position information includes determining the asset position information according to only the first position ID value associated with the first tier. According to some examples, determining the asset position information according to only the first position ID value associated with the first tier includes determining that the first tier is associated with fine-granularity position information and that the second tier is associated with coarse-granularity position information.

According to some examples, determining the asset position information may include determining the asset position information according to both of the first position ID value associated with the first tier and the second position ID value associated with the second tier. In some examples, determining the asset position information according to both of the first position ID value associated with the first tier and the second position ID value associated with the second tier may comprise including, in the asset position information, both of the first position ID value and the second position ID value. According to some examples, determining the tier value associated with each received position ID value may include determining that a first received position ID value is associated with a first tier, and determining that a second received position ID value is associated with the first tier.

In some examples, determining the asset position information based on each determined tier value may include selecting between the first received position ID value and the second received position ID value. According to some examples, selecting between the first received position ID value and the second received position ID value may include determining which of the first received position ID value and the second received position ID value is associated with a greater signal strength. In some examples, determining which of the first received position ID value and the second received position ID value is associated with a greater signal strength may include determining a respective received signal strength indicator (RSSI) value corresponding to each of the first received position ID value and the second received position ID value.

In this manner, aspects of this disclosure may be directed to a device including a memory, and one or more processors. For instance, the device is operable or configured to perform asset tracking According to various examples, the one or more processors are configured to receive, from each of one or more positioning devices, a corresponding position identification (ID) value, determine a tier value associated with each received position ID value, determine asset position information based on each received position ID value and each determined tier value, and transmit the determined asset position information to a receiver. According to some examples, to determine the tier value associated with each received position ID value, the one or more processors are configured to determine that a first received position ID value is associated with a first tier, and to determine that a second received position ID value is associated with a second tier.

According to some examples, to determine the asset position information, the one or more processors are configured to determine the asset position information according to only the first position ID value associated with the first tier. In some examples, to determine the asset position information according to only the first position ID value associated with the first tier, the one or more processors are configured to determine that the first tier is associated with fine-granularity position information and that the second tier is associated with coarse-granularity position information. According to some examples, to determine the asset position information, the one or more processors are configured to determine the asset position information according to both of the first position ID value associated with the first tier and the second position ID value associated with the second tier.

In some examples, to determine the asset position information according to both of the first position ID value associated with the first tier and the second position ID value associated with the second tier, the one or more processors are configured to include both of the first position ID value and the second position ID value in the asset position information. According to some examples, to determine the tier value associated with each received position ID value, the one or more processors are configured to determine that a first received position ID value is associated with a first tier, and to determine that a second received position ID value is associated with the first tier.

According to some examples, to determine the asset position information based on each received position ID value and each determined tier value, the one or more processors are configured to select between the first received position ID value and the second received position ID value. In some examples, to select between the first received position ID value and the second received position ID value, the one or more processors are configured to determine which of the first received position ID value and the second received position ID value is associated with a greater signal strength. According to some examples, to determine which of the first received position ID value and the second received position ID value is associated with a greater signal strength, the one or more processors are configured to determine a respective received signal strength indicator (RSSI) value corresponding to each of the first received position ID value and the second received position ID value.

In this manner, aspects of this disclosure may be directed to a computer-readable storage medium encoded with instructions that, when executed, cause one or more processors of a device to receive, from each of one or more positioning devices, a corresponding position identification (ID) value, to determine a tier value associated with each received position ID value, to determine asset position information based on each received position ID value and each determined tier value, and to transmit the determined asset position information to a receiver.

In this manner, aspects of this disclosure may be directed to an asset tracking system includes one or more landmark tags, each configured to transmit a corresponding position identification (ID) value, and an asset tag configured to receive the corresponding position ID values from the one or more landmark tags, determine a tier value associated with each received position ID value, determine asset position information based on each received position ID value and each determined tier value, and transmit the determined asset position information. The system further includes a receiver configured to receive the asset position information transmitted by the asset tag and relay the received asset position information, and a server configured to receive the asset position information relayed by the receiver, determine a unique asset identifier based on the received asset position information, and associate the receiver with the determined unique asset identifier.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of asset tracking, the method comprising:
receiving, from each of one or more positioning devices, a corresponding position identification (ID) value;
determining a tier value associated with each received position ID value;
determining asset position information based on each received position ID value and each determined tier value; and
transmitting the determined asset position information to a receiver.

2. The method of claim 1, wherein determining the tier value associated with each received position ID value comprises:
determining that a first received position ID value is associated with a first tier; and
determining that a second received position ID value is associated with a second tier.

3. The method of claim 2, wherein determining the asset position information comprises determining the asset position information according to only the first position ID value associated with the first tier.

4. The method of claim 3, wherein determining the asset position information according to only the first position ID value associated with the first tier comprises determining that the first tier is associated with fine-granularity position information and that the second tier is associated with coarse-granularity position information.

5. The method of claim 2, wherein determining the asset position information comprises determining the asset position information according to both of the first position ID value associated with the first tier and the second position ID value associated with the second tier.

6. The method of claim 5, wherein determining the asset position information according to both of the first position ID value associated with the first tier and the second position ID value associated with the second tier comprises including, in the asset position information, both of the first position ID value and the second position ID value.

7. The method of claim 1, wherein determining the tier value associated with each received position ID value comprises:
determining that a first received position ID value is associated with a first tier; and
determining that a second received position ID value is associated with the first tier.

8. The method of claim 7, wherein determining the asset position information based on each determined tier value comprises selecting between the first received position ID value and the second received position ID value.

9. The method of claim 8, wherein selecting between the first received position ID value and the second received position ID value comprises determining which of the first received position ID value and the second received position ID value is associated with a greater signal strength.

10. The method of claim 9, wherein determining which of the first received position ID value and the second received position ID value is associated with a greater signal strength comprises determining a respective received signal strength indicator (RSSI) value corresponding to each of the first received position ID value and the second received position ID value.

11. A device operable to perform asset tracking, the device comprising:
a memory; and
one or more processors configured to:
receive, from each of one or more positioning devices, a corresponding position identification (ID) value;
determine a tier value associated with each received position ID value;
determine asset position information based on each received position ID value and each determined tier value; and
transmit the determined asset position information to a receiver.

12. The device of claim 11, wherein, to determine the tier value associated with each received position ID value, the one or more processors are configured to:
determine that a first received position ID value is associated with a first tier; and
determine that a second received position ID value is associated with a second tier.

13. The device of claim 12, wherein, to determine the asset position information, the one or more processors are configured to determine the asset position information according to only the first position ID value associated with the first tier.

14. The device of claim 13, wherein, to determine the asset position information according to only the first position ID value associated with the first tier, the one or more processors are configured to determine that the first tier is associated with fine-granularity position information and that the second tier is associated with coarse-granularity position information.

15. The device of claim 12, wherein, to determine the asset position information, the one or more processors are configured to determine the asset position information according to both of the first position ID value associated with the first tier and the second position ID value associated with the second tier.

16. The device of claim 15, wherein, to determine the asset position information according to both of the first position ID value associated with the first tier and the second position ID value associated with the second tier, the one or more processors are configured to include both of the first position ID value and the second position ID value in the asset position information.

17. The device of claim 11, wherein, to determine the tier value associated with each received position ID value, the one or more processors are configured to:
determine that a first received position ID value is associated with a first tier; and
determine that a second received position ID value is associated with the first tier.

18. The device of claim 17, wherein, to determine the asset position information based on each received position ID value and each determined tier value, the one or more processors are configured to select between the first received position ID value and the second received position ID value.

19. The device of claim 18, wherein, to select between the first received position ID value and the second received position ID value, the one or more processors are configured to determine which of the first received position ID value and the second received position ID value is associated with a greater signal strength.

20. The device of claim 19, wherein, to determine which of the first received position ID value and the second received position ID value is associated with a greater signal strength, the one or more processors are configured to determine a respective received signal strength indicator (RS SI) value corresponding to each of the first received position ID value and the second received position ID value.

21. A computer-readable storage medium encoded with instructions that, when executed, cause one or more processors of a device to:
receive, from each of one or more positioning devices, a corresponding position identification (ID) value;
determine a tier value associated with each received position ID value;
determine asset position information based on each received position ID value and each determined tier value; and
transmit the determined asset position information to a receiver.

22. An asset tracking system comprising:
one or more landmark tags, each configured to transmit a corresponding position identification (ID) value;
an asset tag configured to:
receive the corresponding position ID values from the one or more landmark tags;
determine a tier value associated with each received position ID value;
determine asset position information based on each received position ID value and each determined tier value; and
transmit the determined asset position information;
a receiver configured to:
receive the asset position information transmitted by the asset tag; and
relay the received asset position information; and
a server configured to:
receive the asset position information relayed by the receiver;
determine a unique asset identifier based on the received asset position information; and
associate the receiver with the determined unique asset identifier.
